(19) United States
(12) Patent Application Publication
(10) Pub. No.: US 2019/0159414 A1
(43) Pub. Date: May 30, 2019

(54) GREEN ECO MAT (GECOMAT) AND METHOD OF AEROPONICS AND HYDROPONICS USING THE SAME

(71) Applicants: Kai-Li Huang, Taichung (TW); Yuan-Te Chen, Taichung (TW); Yuan-Jung Chen, Taichung (TW)

(72) Inventors: Kai-Li Huang, Taichung (TW); Yuan-Te Chen, Taichung (TW); Yuan-Jung Chen, Taichung (TW)

(21) Appl. No.: 15/822,202

(22) Filed: Nov. 26, 2017

(51) Int. Cl. A01G 31/00; A01G 31/02; D03D 1/00; D03D 25/00; B63B 38/00

(52) U.S. Cl. CPC A01G 31/001; A01G 31/02; D03D 1/00; D03D 25/005; D10B 2505/18; D10B 2401/10; D10B 2403/01; D10B 2403/0331; B63B 38/00

(57) ABSTRACT

A green ECO mat (GECOMAT) for aeroponics and hydroponics comprises at least one fabric green ECO mat of cultivation being woven to have arrayed multiple 3D-coniform-shaped (alike pyramid shape) chambers, and at least one floating member connects to the fabric green ECO mat. The chambers of the mat are positioned seed, and the floating member floats the mat in a space full with fluid in the nature to collect moisture in the fluid to provide for germination of the seed and growth of the plant. The harvesting means moves back the floating member and the mat when growth of the plant is completed.

### BACKGROUND OF THE INVENTION

### 1. Fields of the Invention

The present invention relates to a green ECO mat (GECOMAT) and method of aeroponics and hydroponics using the same, and more particularly, to a green ECO mat with three dimension structure having planting function can be used in aeroponics and hydroponics.

### 2. Descriptions of Related Art

In response to the increasing demand for food and the food crisis, human beings have tried to increase food production by using various agricultural methods such as genetically modified, chemical pesticides, chemical fertilizers and growth hormones, and microbial fertilizers. In order to solve the problem of food demand and food crisis, the above-mentioned agricultural methods are also accompanied by a large number of pesticide uses, so that environmental pollution is becoming increasingly serious.

Moreover, the poor environment caused by pollution is directly to human health damage, and later accompanying with climate change and the increase in new pests and diseases of plant, but also reduce crop yields. Under the vicious cycle of soil acidification, the food crisis has not been fundamentally lifted. The requirements of increase of production and organic planting, result in problems to be overcome for the quality and quantity of agricultural environment and crops. Good natural environment resources are limited, in order to sustainable development of agriculture, fundamentally solve the problem of human food shortage and improve food safety and health, so human beings should learn the nature of the natural environment of endless natural circulation principle. To sustainably use the green energies, maximize the effectiveness of transformation of the green energies, to use the principle of natural interaction between material properties and the green energies, by the natural way can create a suitable control for organic environment for agricultural productions, so as to have the opportunity to fundamentally solve the aforementioned problems of vicious cycle caused by traditional agricultural processes and to meet the requirement and safety for food.

The present invention intends to provide a green ECO mat (GECOMAT) and method of aeroponics and hydroponics using the same.

### SUMMARY OF THE INVENTION

The present invention relates to a system with green ECO mat (GECOMAT) for aeroponics and hydroponics comprising fabric green ECO mat of cultivation being woven to have arrayed multiple 3D-coniform-shaped (alike pyramid shape) chambers, floating member connected to the fabric green ECO mat. The chambers of the mat are positioned seed, and the floating member floats the mat in a space full with fluid in the nature to collect moisture in the fluid to provide for germination of the seed and growth of the plant. The harvesting means moves back the floating member and the mat when growth of the plant is completed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a basic construction of the system of the present invention;

FIG. 2 is a perspective view of partial combination of the system of the present invention;

FIG. 3 is a plane view of a second embodiment of the system of the present invention;

FIG. 4 is a plane view of a third embodiment of the system of the present invention;

FIG. 5 shows that multiple green ECO mats stack in order of the present invention, and

FIG. 6 shows the control construction of the airship of the present invention.

### DETAILED DESCRIPTION OF THE PREFERRED EMBODIMENT

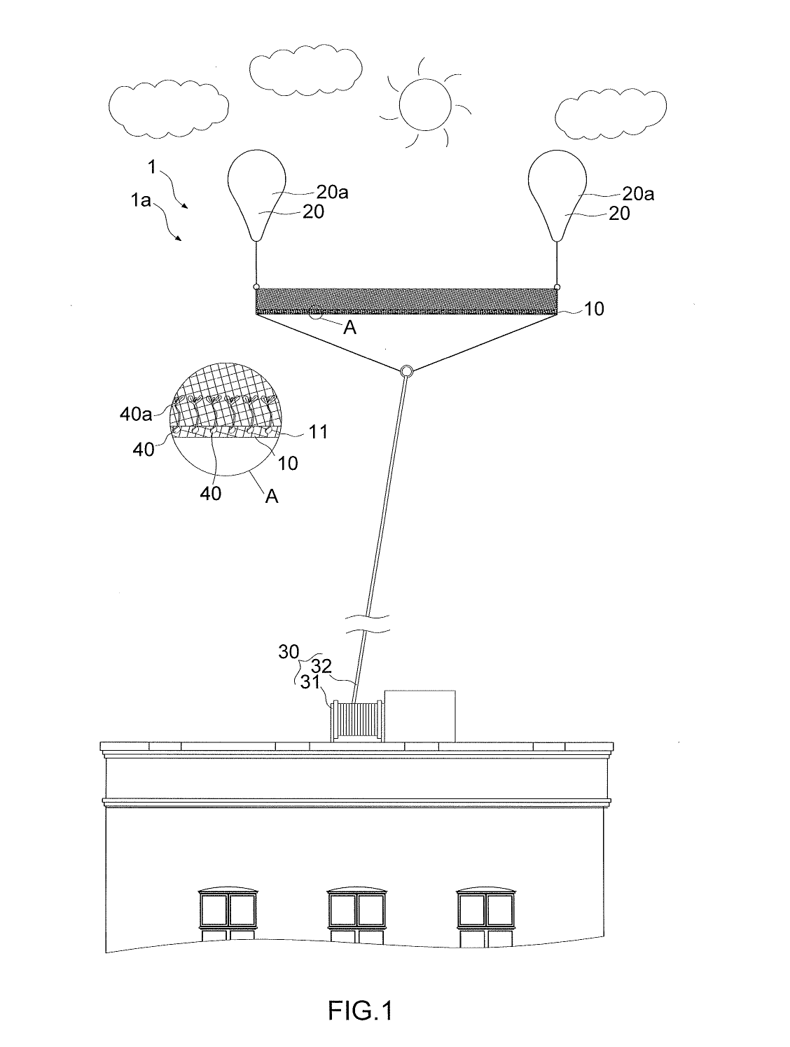

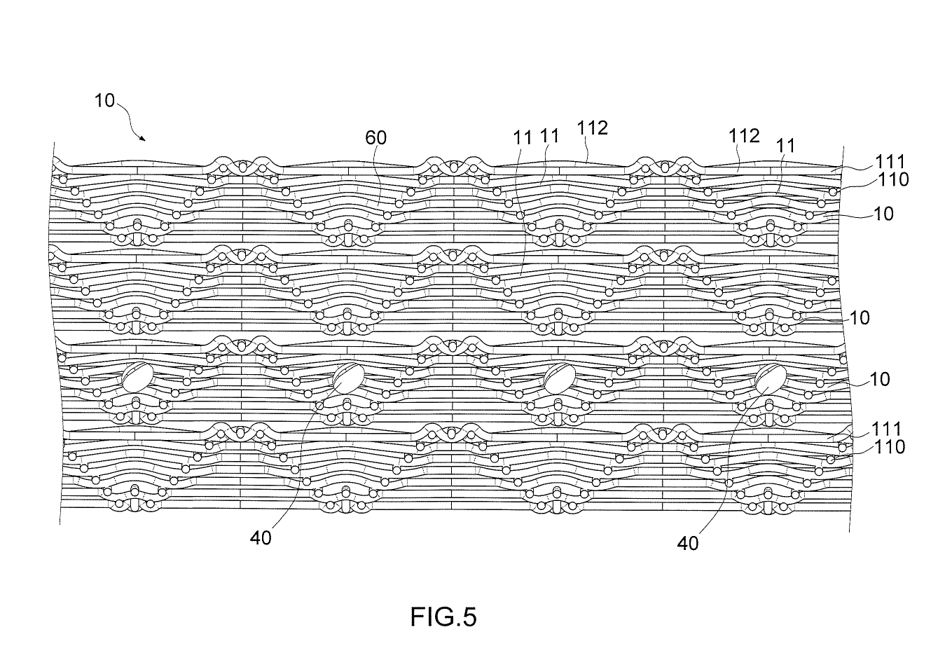

Referring to FIGS. 1 to 6, the system with green ECO mat (GECOMAT) for aeroponics and hydroponics of the present invention comprises at least one fabric green ECO mat 10 of cultivation, at least one floating member 20 and a harvesting means 30. The at least one fabric green ECO mat 10 of cultivation is woven as a net 11 to have arrayed multiple 3D-coniform-shaped (alike pyramid shape) chambers 100 by multiple longitudinal fibers 110 and transversal fibers 111 (referring to FIG. 5). Each chamber 100 has a bigger opening 112 at distal end. The at least one floating member 20 is connected with the at least one fabric green ECO mat 10 of cultivation. Wherein when the 3D-coniform-shaped (alike pyramid shape) chamber 100 is positioned at least one seed 40 of plant (referring to FIG. 5), and the at least one floating member 20 naturally floats in a space 1 full with fluid in the nature by the floating power of the fluid so that the at least one fabric green ECO mat 10 of cultivation also floating in the space 1, the at least one fabric green ECO mat 10 of cultivation collects moisture in the fluid to provide for germination of the seed 40 and growth of the plant 40a (referring to FIGS. 1 and 5). The harvesting means 30 is for moving the at least one floating member 20 and the at least one fabric green ECO mat 10 of cultivation. When growth of the plant is completed, the harvesting means 30 is controlled to move the at least one floating member 20 and the at least one fabric green ECO mat 10 of cultivation with the plant to return to a destination place for collecting the plant.

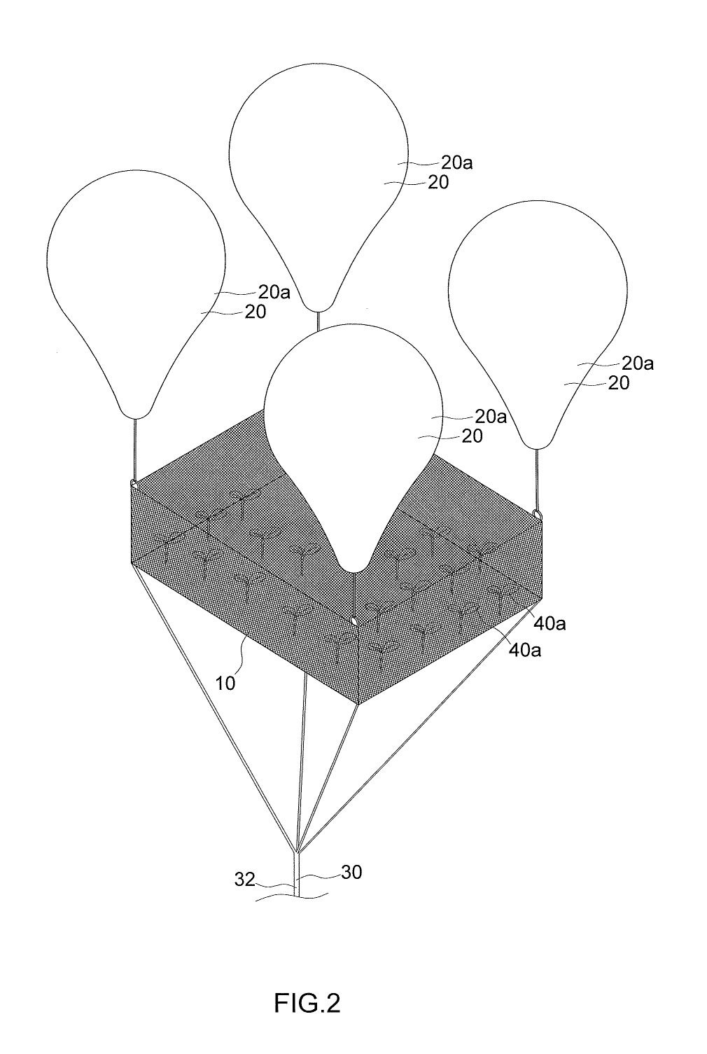

Referring to FIGS. 1 and 2, the at least one floating member 20 is at least one balloon 20a, the space 1 is a sky space 1a, the at least one balloon 20a is for floating the at least one fabric green ECO mat 10 of cultivation in the sky space 1a. The harvesting means 30 comprises a draw mechanism 31 and a wire 32. One end of the wire 32 is connected to the at least one balloon 20a. The draw mechanism 31 rolls the wire 32 so as to draw the at least one balloon 20a and the at least one fabric green ECO mat 10 of cultivation to return to the destination place from the sky space.

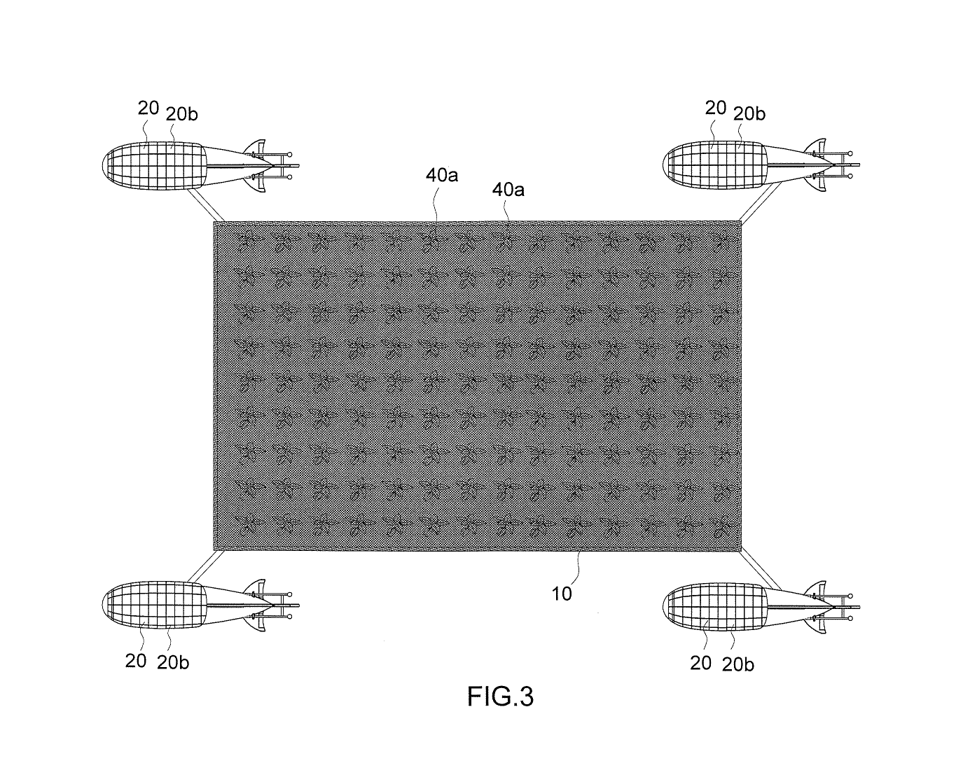

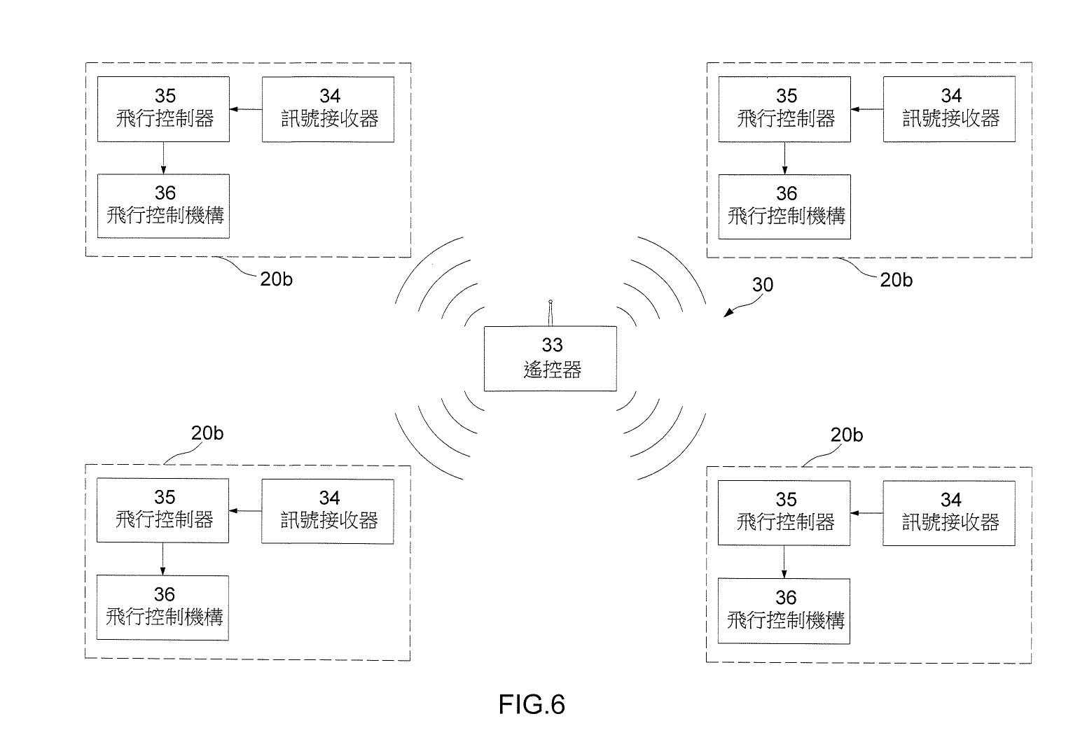

Referring to FIGS. 3 and 6, the at least one floating member 20 is at least one airship 20b, the space is a sky space 1a having a vertical height no less than 8 km with respect to a surface of the earth. The harvesting means 30 comprises a remote controller 33, a signal receiver 34 and a flight controller 35. When the flight controller 35 receives a return control signal from the remote controller 33 through the signal receiver 34, the flight controller 35 produces flight control signals according to the return control signal to activate the flight control mechanism 36 of the airship 20b to let the at least one airship 20b and the at least one fabric green ECO mat 10 of cultivation to return to the destination place from the sky space 1a.

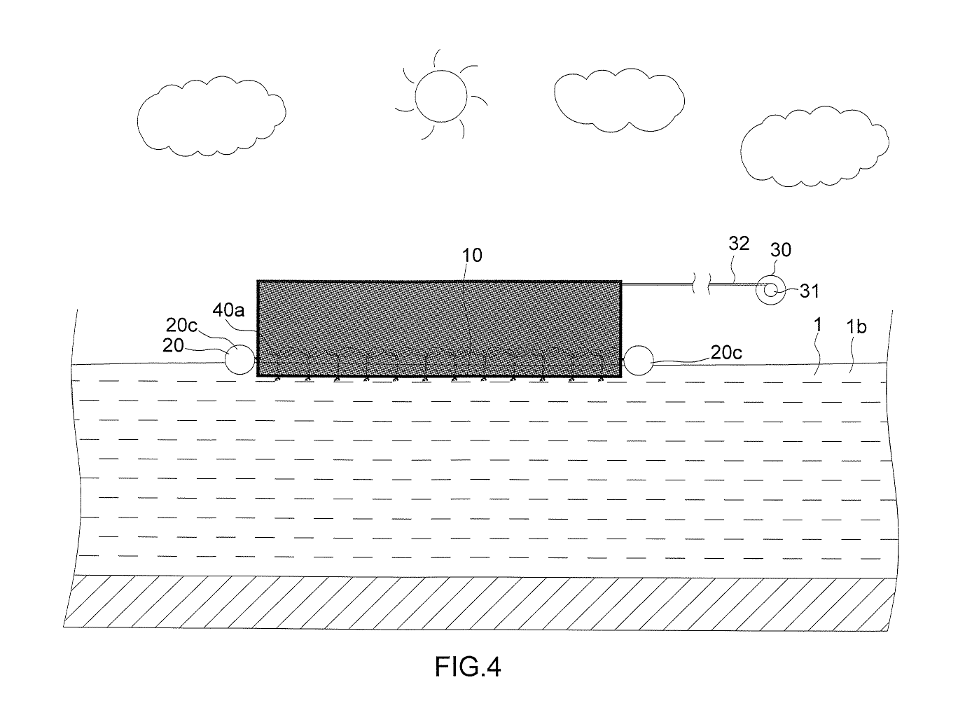

Referring to FIG. 4, wherein the at least one floating member 20 is at least one balloon 20c, the space 1 is a surface of water 1b, the at least one balloon 20c is for floating the at least one fabric green ECO mat 10 of cultivation on the surface of water 1b. The harvesting means 30 comprises a draw mechanism 31 and a wire 32. One end of the wire 32 is connected to the at least one balloon 20c. The draw mechanism 31 rolls the wire 32 so as to draw the at least one balloon 20c and the at least one fabric green ECO mat 10 of cultivation to return to the destination place from the surface of water 1b.

Referring to FIG. 5, wherein the at least one fabric green ECO mat 10 of cultivation is multiple fabric green ECO mats 10 of cultivation, the multiple fabric green ECO mats 10 of cultivation stack together from a top to a bottom in order. Moreover, the fabric green ECO mat 10 of cultivation is coated with a layer of fertilizers 60 for germination of the seed 40 and growth of the plant 40a.

While we have shown and described the embodiment in accordance with the present invention, it should be clear to those skilled in the art that further embodiments may be made without departing from the scope of the present invention.

What is claimed is:

1. A green ECO mat (GECOMAT) for aeroponics and hydroponics comprising:
at least one fabric green ECO mat of cultivation being woven to have arrayed multiple 3D-coniform-shaped (alike pyramid shape) chambers by multiple longitudinal fibers and transversal fibers.

2. A system for aeroponics and hydroponics comprising:
at least one fabric green ECO mat of cultivation being woven to have arrayed multiple 3D-coniform-shaped (alike pyramid shape) chambers by multiple longitudinal fibers and transversal fibers;
at least one floating member being connected with the at least one fabric green ECO mat of cultivation;
wherein when the 3D-coniform-shaped (alike pyramid shape) chamber being positioned at least one seed of plant, and the at least one floating member naturally floating in a space full with fluid in the nature by the floating power of the fluid so that the at least one fabric green ECO mat of cultivation also floating in the space, the at least one fabric green ECO mat of cultivation collecting moisture in the fluid to provide for germination of the seed and growth of the plant, and
a harvesting means for moving the at least one floating member and the at least one fabric green ECO mat of cultivation, wherein when growth of the plant being completed, the harvesting means being controlled to move the at least one floating member and the at least one fabric green ECO mat of cultivation with the plant to return to a destination place for collecting the plant.

3. The system as claimed in claim 2, wherein the at least one floating member is at least one balloon, the space is a sky space, the at least one balloon is for floating the at least one fabric green ECO mat of cultivation in the sky space.

4. The system as claimed in claim 3, wherein the harvesting means comprises a draw mechanism and a wire; one end of the wire is connected to the at least one balloon; the draw mechanism draws the wire the at least one balloon and the at least one fabric green ECO mat of cultivation to return to the destination place from the sky space.

5. The system as claimed in claim 2, wherein the at least one floating member is at least one airship, the space is a sky space having a vertical height no less than 8 km with respect to a surface of the earth.

6. The system as claimed in claim 5, wherein the harvesting means comprises a remote controller, a signal receiver and a flight controller; when the flight controller receives a return control signal from the remote controller through the signal receiver, the flight controller produces flight control signals according to the return control signal to activate a flight control mechanism of the airship to let the at least one airship and the at least one fabric green ECO mat of cultivation to return to the destination place from the sky space.

7. The system as claimed in claim 2, wherein the at least one floating member is at least one balloon, the space is a surface of water, the at least one balloon is for floating the at least one fabric green ECO mat of cultivation on the surface of water.

8. The system as claimed in claim 7, wherein the harvesting means comprises a draw mechanism and a wire; one end of the wire is connected to the at least one balloon; the draw mechanism draws the wire the at least one balloon and the at least one fabric green ECO mat of cultivation to return to the destination place from the surface of water.

9. The system as claimed in claim 2, wherein the at least one fabric green ECO mat of cultivation is coated with fertilizers for germination of the seed and growth of the plant.

10. The system as claimed in claim 2, wherein the at least one fabric green ECO mat of cultivation is multiple fabric green ECO mats of cultivation, the multiple fabric green ECO mats of cultivation stack together from a top to a bottom in order.
